(19) United States
(12) Patent Application Publication
(10) Pub. No.: US 2017/0208611 A1
(43) Pub. Date: Jul. 20, 2017

(54) Protecting Critical Communication Activity From A Tune-Away

(71) Applicant: QUALCOMM Incorporated, San Diego, CA (US)

(72) Inventors: Amith Chincholi, Sunnyvale, CA (US); Liangchi Hsu, San Diego, CA (US); Sharif Matin, San Diego, CA (US); Jia Tang, San Jose, CA (US); Reza Shahidi, San Diego, CA (US)

(21) Appl. No.: 14/996,597

(22) Filed: Jan. 15, 2016

(51) Int. Cl. H04W 72/12; H04B 17/318

(52) U.S. Cl. CPC H04W 72/1215; H04B 17/318

(57) ABSTRACT

Various embodiments include multi-subscription multi-standby communication devices and methods for managing communication activity. A device processor of the multi-subscription multi-standby communication device may determine a timing of an upcoming tune-away from a first subscription to a second subscription, and may determine whether an upcoming communication activity on the first subscription is a critical communication activity. The device processor may determine whether the upcoming tune-away and the upcoming communication activity will collide in response to determining that the upcoming communication activity is a critical communication activity, and may schedule one or both of the upcoming critical communication activity and the tune-away to prevent the collision in response to determining that the upcoming tune-away and the upcoming communication activity will collide.

### BACKGROUND

A multi-subscription multi-standby communication device may include one or more Subscriber Identity Module (SIM) cards that provide users with access to multiple separate mobile communication networks. Each SIM may be associated with a different service provider subscription, enabling the multi-subscription multi-standby communication device to communicate with one or more communication networks. Each SIM or subscription may also be associated with a radio access technology (RAT).

A multi-subscription communication device that includes one or more SIMs and connects to two or more separate mobile communication networks using one or more shared radio frequency (RF) resources/radios may be termed a “multi-standby” communication device. One example of a multi-subscription multi-standby communication device is a dual-SIM-dual-standby (DSDS) communication device, which includes two SIM cards that share a set of radio frequency (RF) circuitry (referred to as an “RF chain” or a “RF resource chain”) to communicate with two separate mobile communication networks on behalf of their respective subscriptions. Another example is a single-radio LTE (SRLTE) communication device, which includes one SIM card/subscription associated with two (or more) subscriptions that share a single shared RF resource chain to communicate with one or more multi-subscription multi-standby communication networks on behalf of the multiple subscriptions.

Typically, only one subscription can use an RF resource chain to communicate with its mobile network at a time. Therefore, the communication device periodically interrupts RF operations of an active subscription (“first subscription”) so that the idle subscription (“second subscription”) can use the shared RF resource. This is called a “tune-away” or a “tune-away event” since the RF resource must tune away from the frequency bands and/or channels of the RAT associated with the first subscription and must tune to frequency bands/channels of the RAT associated with the second subscription. However, the interruption of first subscription communication activity caused by the tune-away (a “tune-away gap”) may prevent critical measurements and or signaling of the first subscription, which can cause degraded performance, call drop, or radio link failure (RLF).

### SUMMARY

Various embodiments include methods and multi-subscription multi-standby communication devices implementing methods for managing communication activity. Various methods may include determining a timing of an upcoming tune-away from a first subscription to a second subscription, determining whether an upcoming communication activity on the first subscription is a critical communication activity, determining whether a collision will occur between the upcoming tune-away and the upcoming communication activity in response to determining that the upcoming communication activity is an upcoming critical communication activity, and scheduling one or both of the upcoming critical communication activity and the upcoming tune-away to prevent the collision in response to determining that the upcoming tune-away and the upcoming communication activity will collide.

Some embodiments may further include performing the critical communication activity and the tune-away as scheduled to prevent the collision. In some embodiments, the upcoming critical communication activity may be one of a transmission activity or a reception activity. In some embodiments, the upcoming critical communication activity may relate to a serving cell change. In such embodiments, the upcoming critical communication activity may include one or more of a measurement of a serving cell signal, a measurement of a neighbor cell signal, information related to reconfiguring a communication link, a request for information related to reconfiguring a communication link, intra-radio access technology messaging, active set update messaging, and active set confirmation messaging.

In some embodiments, scheduling one or both of the upcoming critical communication activity and the upcoming tune-away to prevent the collision in response to determining that the upcoming tune-away and the upcoming communication activity will collide may include scheduling a transmission activity such that a reception activity related to the transmission activity does not coincide with the tune-away.

In some embodiments, scheduling one or both of the upcoming critical communication activity and the upcoming tune-away to prevent the collision in response to determining that the upcoming tune-away and the upcoming communication activity will collide may include determining one or more characteristics of a communication link of the multi-subscription multi-standby communication device on the first subscription, and scheduling the one or both of the upcoming critical communication activity and the upcoming tune-away to prevent the collision based on the determined one or more characteristics of the communication link. In such embodiments, the one or more characteristics of the communication link of the multi-subscription multi-standby communication device on the first subscription may include one or more of a signal level of a signal of the communication link, a transmission power of the signal of the communication link, a spectral density of the signal of the communication link, a block error rate (BLER) of the signal of the communication link, a number of channel grants received from a communication network of the first subscription, a number of data-received indications received from the communication network, a number of data-received indications sent to the communication network, a number of data-not received indications received from the communication network, a number of data-not received indications sent to the first subscription communication network, a speed of motion of the multi-subscription multi-standby communication device, a direction of motion of the multi-subscription multi-standby communication device, a High Speed Physical Download Shared Channel (HS-PDSCH) signal-to-noise ratio, and an estimate of a Radio Link Control (RLC) acknowledgement delay.

In some embodiments, scheduling one or both of the upcoming critical communication activity and the upcoming critical communication activity to prevent the collision in response to determining that the upcoming tune-away and the upcoming communication activity will collide may include scheduling the critical communication activity before the tune-away. In some embodiments, scheduling one or both of the upcoming critical communication activity and the upcoming tune-away to prevent the collision in response to determining that the upcoming tune-away and the upcoming communication activity will collide may include scheduling the critical communication activity after the tune-away. In some embodiments, scheduling one or both of the upcoming critical communication activity and the upcoming tune-away to prevent the collision in response to determining that the upcoming tune-away and the upcoming communication activity will collide may include scheduling the critical communication activity before the tune-away by adjusting a tune-away timing parameter. In some embodiments, scheduling one or both of the upcoming critical communication activity and the upcoming tune-away to prevent the collision in response to determining that the upcoming tune-away and the upcoming communication activity will collide may include adjusting a communication activity timing parameter.

Various embodiments further include a multi-subscription multi-standby communication device having a memory, a radio frequency (RF) resource, and a processor coupled to the memory and the RF resource and configured with processor executable instructions to perform operations of the methods described above. Various embodiments include a multi-subscription multi-standby communication device having means for performing functions of the methods described above. Various embodiments include a non-transitory processor-readable storage medium having stored thereon processor-executable instructions configured to cause a processor of a multi-subscription multi-standby communication device to perform operations of the methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of various embodiments, and not to limit various embodiments.

FIG. 1 is a component block diagram of a communication system suitable for use with various embodiments.

FIG. 2 is a component block diagram of a multi-subscription multi-standby communication device according to various embodiments.

FIGS. 3A and 3B are each a timeline illustrating communication activities on a first subscription and a tune-away to a second subscription by a multi-subscription multi-standby communication device according to various embodiments.

FIG. 4 is a process flow diagram illustrating a method of managing transmissions method for managing communication activity on a first subscription to protect a critical first subscription communication activity from a tune-away on a multi-subscription multi-standby communication device according to various embodiments.

FIG. 5 is a process flow diagram illustrating a method of managing transmissions method for managing communication activity on a first subscription to protect a critical first subscription communication activity from a tune-away on a multi-subscription multi-standby communication device according to various embodiments.

FIG. 6 is a component block diagram of a multi-subscription multi-standby communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented in multi-subscription multi-standby communication devices that enable reception of cell signals on a first network while reducing degradation of throughput of data of an active communication session on a second network by appropriately scheduling tune-aways to the first network.

The terms “multi-subscription multi-standby communication device” and “MSMS communication device” refer to any one or all of cellular telephones, smartphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms which include a programmable processor, a memory, and one or more shared RF resources, and which are configured to support communications over two or more subscriptions. Various embodiments may be particularly useful in any communication devices that can support multiple wireless network subscriptions and communication sessions with two or more communication networks.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

References to “first network,” “first subscription,” “second network” and “second subscription” are arbitrary and are used to refer to two or more subscriptions/networks generally because at any given time either subscription/network may be in an active mode (on an active voice or data call) or a standby mode. For example, at a first time, a first subscription with a first network may be on an active data call (and thus a “first subscription) while a second subscription with a second network is in the standby mode (and thus a “second” subscription), and at a second time, the second subscription may enter an active data call (becoming the “first” subscription) and the first subscription may enter the standby mode (becoming the “second” subscription). Also, references to “first” and “second” subscriptions and networks is not intended to imply that the embodiments are limited to two subscriptions sharing one radio frequency (RF) resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

In multi-subscription multi-standby communication devices, only one subscription may use each RF resource chain to communicate with its communication network at a time. Even when a subscription is in an idle mode or a standby mode, meaning the subscription is not actively communicating with the network, the subscription may still need to periodically receive access to a shared RF resource chain in order to perform various network operations. For example, an idle subscription may need the shared RF resource chain at regular intervals to perform idle mode operations, to receive network-paging messages in order to remain connected to the network, etc. on behalf of the idle subscription. Therefore, it is possible that at certain times the multiple subscriptions sharing an RF resource chain will need to use the RF resource chain to communicate with their respective mobile networks simultaneously.

The multi-subscription multi-standby communication device may perform a tune-away in which a subscription that is actively using a shared RF resource chain interrupts RF operations to permit an idle subscription to use the shared RF resource chain. After network communications via the idle subscription are complete, the communication device may switch RF resource chain access back from the idle subscription to the active subscription. Examples of idle-standby mode operations may include one or more of page monitoring (e.g., discontinuous reception), system information monitoring (e.g., receiving and decoding a broadcast control channel), cell reselection measurements to determine whether to initiate reselection operations to a neighboring cell, updating the second subscription network with the current location of the multi-subscription multi-standby communication device, receiving Short Message Service (SMS) messages, and receiving mobile-terminated calls (sometimes collectively referred to herein as tune-away operations).

Performing the tune-away to the second subscription may interrupt communication activities of the first subscription. For example, as a result of the tune-away, scheduled transmission activities of the first subscription may be prevented, or scheduled reception activities of the first subscription may be missed, and thus data for the first subscription may be lost or corrupted. As another example, measurement activities, communication link maintenance signaling, and other critical communications activities may be interrupted or missed due to the performance of the tune-away to the second subscription. Thus, operations performed by a processor of a multi-subscription multi-standby communication device may include scheduling communication activities on the first subscription to prevent a timing conflict (a “collision”) between a scheduled tune-away to the second subscription (i.e., preventing critical communication activities from coinciding with tune-aways).

Various embodiments enable a processor of a multi-subscription multi-standby communication device to manage communication activity on a first subscription to schedule a critical first subscription communication activity so that the critical communication activity does not coincide with a scheduled tune-away to a second subscription. The multi-subscription multi-standby communication device may determine a timing of an upcoming tune-away from the first subscription to the second subscription, and may determine a timing of an upcoming communication activity on the first subscription. The multi-subscription multi-standby communication device may also determine that the upcoming communication activity on the first subscription is a critical communication activity. The critical communication activity may include signal measurement activities, channel maintenance signaling, and other communication activities performed by the multi-subscription multi-standby communication device related to searching for, establishing, and/or maintaining a communication link on the first subscription. In some embodiments, the critical communication activity may include communications on the first subscription related to changing a serving cell of the first subscription.

Based on the timing of the upcoming tune-away and the timing of the upcoming critical communication activity, the multi-subscription multi-standby communication device may determine whether the tune-away and the critical communication activity will overlap in time (collide). In response to determining that the tune-away and the critical communication activity will collide, the multi-subscription multi-standby communication device may determine and/or estimate one or more characteristics of a communication link between the multi-subscription multi-standby communication device and a communication network of the first subscription. For example, the multi-subscription multi-standby communication device may determine and/or estimate one or more characteristics of a communication link with the base station of the first subscription communication network.

Communication link characteristics that the multi-subscription multi-standby communication device may determine and/or estimate include a signal level (e.g., a signal strength or signal quality, such as a common pilot channel (CPICH) signal to noise ratio (SNR) estimate, or a channel quality indicator (CQI)) of the communication link. A signal quality may also include a determination of whether a High Speed Physical Download Shared Channel (HS-PDSCH) SNR exceeds a threshold level (e.g., a threshold level of dB). A signal quality may also include a determination of whether a Radio Link Control (RLC) acknowledgment (ACK) delay exceeds a threshold time period (e.g., a threshold in milliseconds).

The communication link characteristics may also include a transmission power of a signal of the communication link, a spectral density of a signal of the communication link (e.g., signal energy over interference, such as Ec/lo), and a block error rate (BLER) of the first subscription. Communication link characteristics may also include transmit power control (TPC) symbols of the first subscription received by the multi-subscription multi-standby communication device (e.g., determining whether a number of instructions to increase transmit power over a period of time exceed a threshold), a number of channel grants received by the multi-subscription multi-standby communication device from the first subscription, a number of data-received indications (e.g., ACKs) received by the multi-subscription multi-standby communication device from the first subscription, and a number of data-not received indications (e.g., NACKs) received by the multi-subscription multi-standby communication device from the first subscription. One or more of the communication link characteristics may be determined over a period of time. The communication link characteristics may further include combinations of any of the foregoing.

Based on the one or more determined and/or estimated characteristics of the communication link, the multi-subscription multi-standby communication device may schedule the critical communication activity and/or the tune-away to prevent the collision. In some embodiments, the multi-subscription multi-standby communication device may schedule the critical communication activity before the upcoming tune-away. In some embodiments, this may involve performing the critical communication activity earlier than originally scheduled. In some embodiments, the multi-subscription multi-standby communication device may schedule the critical communication activity after the upcoming tune-away. In some embodiments, this may involve delaying performance of the critical communication activity later than originally scheduled. In some embodiments, the multi-subscription multi-standby communication device may schedule the tune-away earlier or later to prevent a collision with the critical communication activity. In some embodiments, the multi-subscription multi-standby communication device may schedule a transmission activity so that a later reception activity that is related to or responsive to the transmission activity does not occur during the tune-away. In some embodiments, the multi-subscription multi-standby communication device may schedule a reception activity so that a later transmission activity that is related to or responsive to the reception activity does not occur during the tune-away.

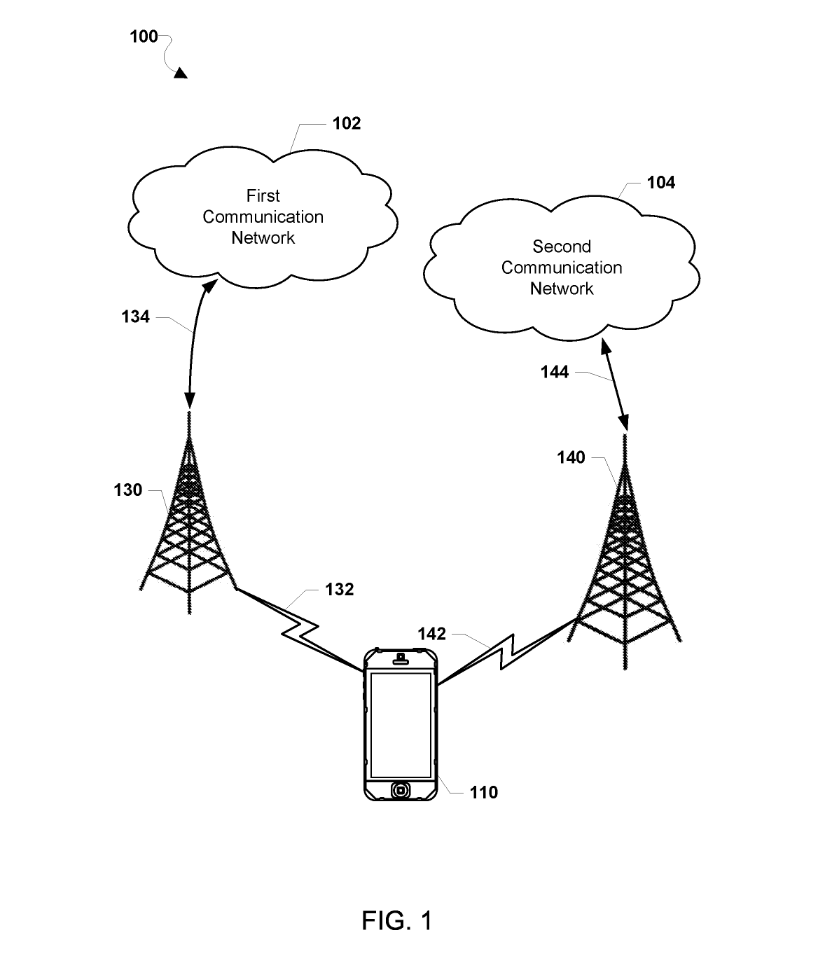

Various embodiments may be implemented in multi-subscription multi-standby communication devices that may operate within a variety of communication systems particularly systems that include two or more communication networks. FIG. 1 illustrates a communication system 100 suitable for use with various embodiments. A multi-subscription multi-standby communication device 110 may communicate with the first communication network 102 through a communication link 132 to the first base station 130. In some embodiments, the multi-subscription multi-standby communication device 110 may include a multi-subscription multi-standby (MSMS) communication device. The multi-subscription multi-standby communication device 110 may also communicate with the second mobile network 104 through a communication link 142 to the second base station 140. The first base station 130 may communicate with the first communication network 102 over a wired or wireless communication link 134, and the second base station 140 may communicate with the second communication network 104 over a wired or wireless communication link 144. The communication links 134 and 144 may include fiber optic backhaul links, microwave backhaul links, and other similar communication links.

Each of the communication networks 102 and 104 may support communications using one or more RATs, and each of the wireless communication links 132 and 142 may include cellular connections that may be made through two-way wireless communication links using one or more RATs. Examples of RATs may include 3GPP Long Term Evolution (LTE), Global System for Mobility (GSM), Worldwide Interoperability for Microwave Access (WiMAX), Code Division Multiple Access (CDMA), Wideband CDMA (WCDMA), Time Division Multiple Access (TDMA), Single-Carrier Radio Transmission Technology (1xRTT), Evolution-Data Optimized (EV-DO), and other RATs, such as members of the Institute of Electrical and Electronics Engineers (IEEE) 802 family of RATs, including Wi-Fi, Bluetooth, ZigBee, and other similar RATs. While the communication links 132 and 142 are illustrated as single links, each of the communication links may include a plurality of frequencies or frequency bands, each of which may include a plurality of logical channels. Additionally, each of the communication links 132 and 142 may utilize more than one RAT.

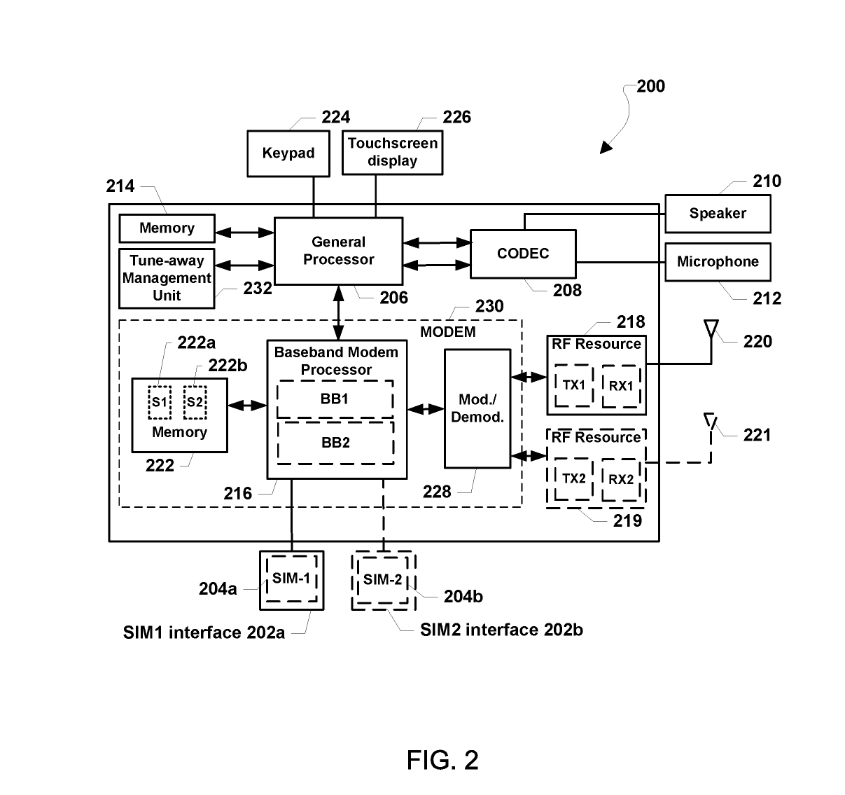

FIG. 2 is a component block diagram of a multi-subscription multi-standby communication device 200 suitable for implementing various embodiments. With reference to FIGS. 1 and 2, in various embodiments, the multi-subscription multi-standby communication device 200 may be similar to the multi-subscription multi-standby communication device 110. The multi-subscription multi-standby communication device 200 may include a first SIM interface 202a, which may receive a first identity module SIM-1 204a that may be associated with a first subscription. The multi-subscription multi-standby communication device 200 may optionally also include a second SIM interface 202b, which may receive a second identity module SIM-2 204b that may be associated with a second subscription.

A SIM in various embodiments may be a Universal Integrated Circuit Card (UICC) that is configured with SIM and/or USIM (Universal Subscriber Identity Module) applications, enabling access to, for example, GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The multi-subscription multi-standby communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general-purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to the RF resource 218 for transmission. The modulator/demodulator 228 may also extract an information-bearing signal from a modulated carrier wave received from the RF resource 218, and may provide the demodulated signal to the baseband modem processor 216. The modulator/demodulator 228 may be or include a digital signal processor (DSP).

In some optional embodiments, the multi-subscription multi-standby communication device 200 may include an optional RF resource 219 configured similarly to the RF resource 218 and coupled to an optional wireless antenna 221. In such embodiments, the multi-subscription multi-standby communication device 200 may leverage the multiple RF resources 218, 219 and antennae 220, 221 to perform diversity receiver reception during a tune-away.

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the multi-subscription multi-standby communication device 200 (e.g., SIM-1 204a, SIM-2 204b) may be coupled to the modem 230 and may be associated with or permitted to use an RF resource. The term “RF resource chain” may be used to refer to all of the circuitry used to send and/or receive RF signals, which may include the baseband modem processor 216 that performs baseband/modem functions for communicating with/controlling a RAT, one or more radio units including transmitter and receiver components that are shown as RF resource 218, and optional RF resource 219, one or more of the wireless antenna 220 and the optional wireless antenna 221, and additional circuitry that may include one or more amplifiers and radios. In some embodiments, an RF resource may share a common baseband modem processor 216 (i.e., a single device that performs baseband/modem functions for all RATs on the multi-subscription multi-standby communication device). In some embodiments, each RF resource may include the physically or logically separate baseband processors (e.g., BB1, BB2).

In some embodiments, the multi-subscription multi-standby communication device may have a single RF resource (e.g., the RF resource 218) that may be shared among two or more SIMs. In some embodiments, the multi-subscription multi-standby communication device may include more than one RF resource (e.g., the RF resources 218, 219), but may operate in a mode or modes in which two or more SIMs share access to one RF resource. The RF resources 218, 219 may include transceivers associated with one or more RATs and may perform transmit/receive functions for the multi-subscription multi-standby communication device 200 on behalf of their respective RATs. The RF resources 218, 219 may include separate transmit and receive circuitry. In some embodiments, one of the RF resources 219 may include only receive circuitry. The RF resources 218, 219 may each be coupled to a wireless antenna (e.g., the first wireless antenna 220 and the second wireless antenna 221). The RF resources 218, 219 may also be coupled to the modem 230 (e.g., via the modulator/demodulator 228, the baseband modem processor 216, or another component).

In some embodiments, the general-purpose processor 206, memory 214, baseband processor(s) 216, and the RF resources 218, 219 may be included in the multi-subscription multi-standby communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the multi-subscription multi-standby communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the multi-subscription multi-standby communication device 200 to enable communication between them.

Functioning together, the two SIMs 204a, 204b, the baseband processor(s) 216, RF resources 218, 219, and the antennas 220, 221 may enable communications on two or more RATs. For example, one SIM, baseband processor, and RF resource may be configured to support two different RATs. In some embodiments, more RATs may be supported on the multi-subscription multi-standby communication device 200 by adding more SIM cards, SIM interfaces, RF resources, and antennas for connecting to additional mobile networks.

The multi-subscription multi-standby communication device 200 may optionally include a tune-away management unit 232 configured to manage the respective access of subscriptions associated with the first and second SIMs 204a, 204b to the RF resource 218 (and optionally the RF resource 219) in anticipation of or during a tune-away. In some embodiments, the tune-away management unit 232 may determine whether to initiate a tune-away from a first subscription to a second subscription or whether to prevent or block a tune-away in order to improve data reception on the first subscription during the duration of the tune-away. In some embodiments, the tune-away management unit 232 may be implemented within the general-purpose processor 206. In other embodiments, the tune-away management unit 232 may be implemented as a separate hardware component (i.e., separate from the general-purpose processor 206). In some embodiments, the tune-away management unit 232 may be implemented as a software application stored within the memory 214 and executed by the general-purpose processor 206.

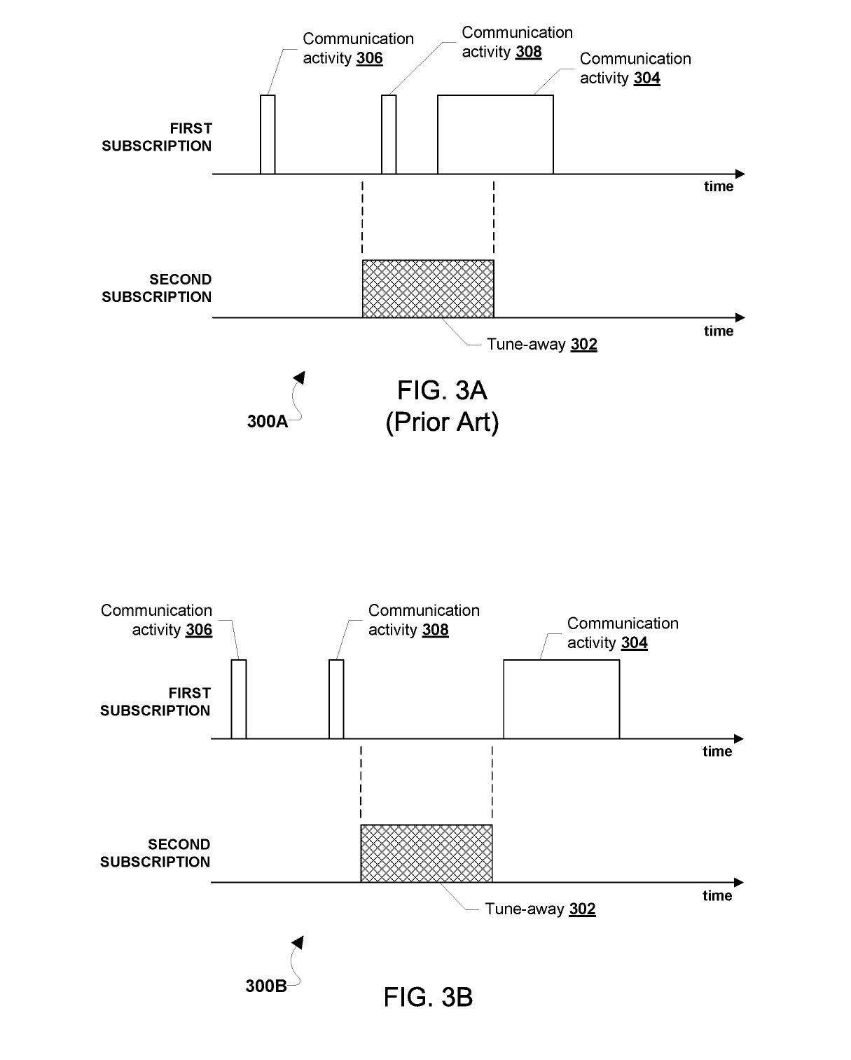

FIG. 3A illustrates a timeline 300A of communication activities on a first subscription and a tune-away to a second subscription by a multi-subscription multi-standby communication device according to various embodiments. With reference to FIGS. 1-3A, activities in the timeline 300A may be performed by a multi-subscription multi-standby communication device (e.g., the multi-subscription multi-standby communication device 102, 200), such as under the control of a processor (e.g., the general-purpose processor 206, the baseband processor 216, a separate controller, and/or the like) of the multi-subscription multi-standby communication device (i.e., a device processor).

The multi-subscription multi-standby communication device may perform a tune-away 302 to conduct communication activities on the second subscription. Such second subscription communication activities may include monitoring for a paging message (e.g., of an idle subscription), monitoring for system information such as may be received over a broadcast control channel or another control channel, performing neighbor cell measurements to determine whether to initiate cell selection or reselection operations, sending an update to the second subscription network with the current location of the multi-subscription multi-standby communication device, receiving SMS messages, receiving mobile-terminated calls, and other tune-away operations.

The multi-subscription multi-standby communication device may also perform a communication activity on the first subscription. Such communication activity may include sending or receiving voice data, sending or receiving application data, performing communication activities related to signal measurements, communication link maintenance, neighbor cell signal acquisition and/or scanning, and other first subscription communication activities. A communication activity that is performed on the first subscription may overlap in time partially or completely with the tune-away. For example, the communication activity 304 may partially overlap in time with the tune-away 302. As another example, a communication activity 308 may completely overlap in time with the tune-away 302.

In some embodiments, one communication activity may be related to or responsive to another communication activity. For example, the communication activity 308 may be related to a communication activity 306. Either of communication activities 306 and 308 may be a transmission activity or a reception activity. For example, the communication activity 306 may be a transmission by the multi-subscription multi-standby communication device to the first subscription communication network, and the communication activity 308 may be a reception activity in which the multi-subscription multi-standby communication device receives a message from the first subscription communication network related to the transmission activity of the communication activity 306. As another example, the communication activity 308 may be a transmission activity in which the multi-subscription multi-standby communication device transmits a message to the first subscription communication network related to one or more messages received during a reception activity performed during the communication activity 306.

FIG. 3B illustrates a timeline 300B of communication activities on a first subscription and a tune-away to a second subscription by a multi-subscription multi-standby communication device according to various embodiments. With reference to FIGS. 1-3B, activities in the timeline 300B may be performed by a multi-subscription multi-standby communication device (e.g., the multi-subscription multi-standby communication device 102, 200), such as under the control of a processor (e.g., the general-purpose processor 206, the baseband processor 216, a separate controller, and/or the like) of the multi-subscription multi-standby communication device (i.e., a device processor).

In some embodiments, the multi-subscription multi-standby communication device may schedule a communication activity (such as a critical communication activity) on the first subscription so that the communication activity does not coincide with a tune-away to the second subscription. For example, the multi-subscription multi-standby communication device may schedule performance of the communication activity 304 after the tune-away 302. Alternatively, for example, the multi-subscription multi-standby communication device may schedule performance of the communication activity (e.g., 308) before the tune-away 302. As another example, the multi-subscription multi-standby communication device may schedule one communication activity so that the performance of a related communication activity does not collide with the tune-away 302. For instance, the multi-subscription multi-standby communication device may schedule the communication activity 306 earlier than originally scheduled so that communication activity 308, which is related to the communication activity 306, is performed before the tune-away 302. Similarly, the multi-subscription multi-standby communication device may delay the performance of the communication activity 306 so that it occurs later than originally scheduled so that the communication activity 308 is performed after the tune-away 302.

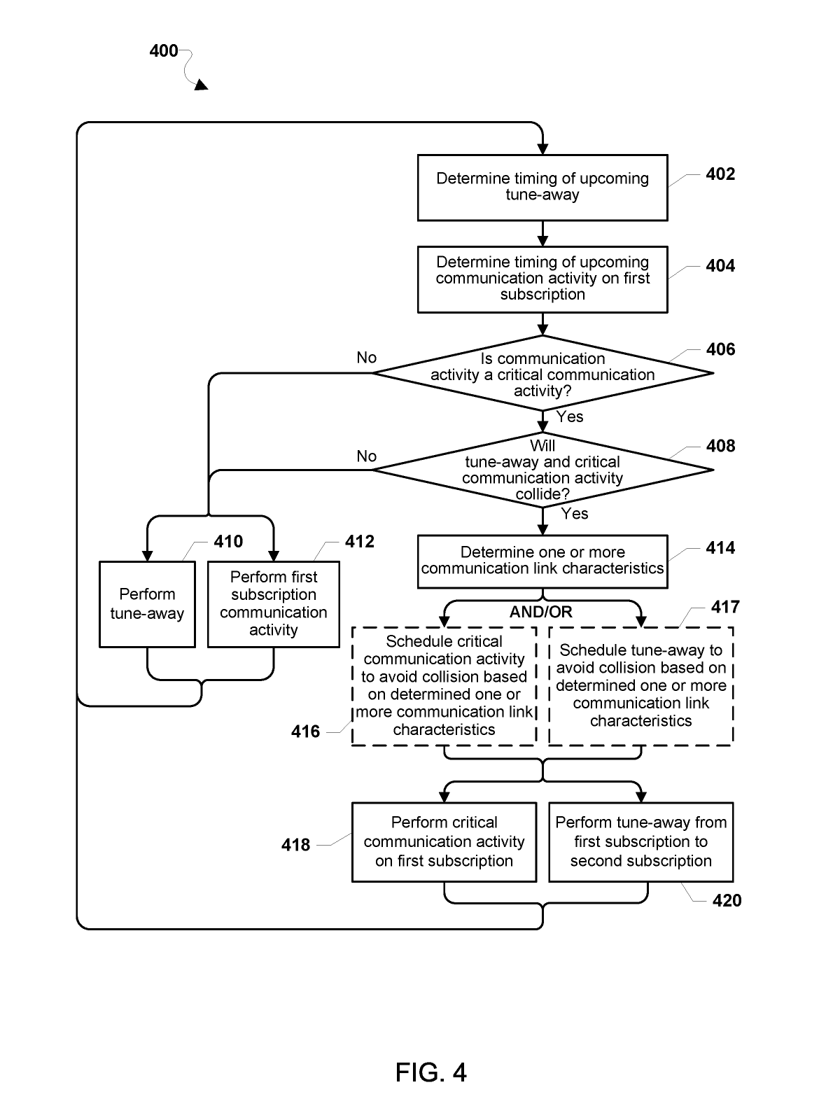

FIG. 4 illustrates a method 400 for managing communication activity on a first subscription to protect a critical first subscription communication activity from a tune-away according to various embodiments. With reference to FIGS. 1, 3A and 4, the method 400 may be implemented by a multi-subscription multi-standby communication device (e.g., the multi-subscription multi-standby communication device 102, 200), such as under the control of a processor (e.g., the general-purpose processor 206, the baseband processor 216, a separate controller, and/or the like) of the multi-subscription multi-standby communication device (i.e., a device processor).

In block 402, the device processor may determine a timing of an upcoming tune-away from the first subscription to the second subscription. In some embodiments, the device processor may determine the timing of the tune-away based on a radio access technology used for the second subscription. The timing of the upcoming tune-away determined in block 402 may also include a tune-away duration, as well as a time at which the beginning (and/or end) of the tune-away is scheduled.

In block 404, the device processor may determine a timing of an upcoming communication activity on the first subscription. The communication activity on the first subscription may include transmission and/or reception of information to or from the first subscription communication network. The communication activity may also include signal measurements, paging message monitoring, transmission and/or reception of a communication link maintenance messaging, and other communication activities.

In determination block 406, the device processor may determine whether the upcoming communication activity on the first subscription is a critical communication activity. In particular embodiments, the critical communication activity may relate to serving cell changes (e.g., SSC messaging). A critical communication activity may include performing a measurement of a serving cell signal and/or a neighbor cell signal (e.g., a signal level report related to a pilot channels such as a Common Pilot Channel (CPICH), a neighbor cell signal level measurement, or another signal level measurement). The critical communication activity may also include transmitting and/or receiving information related to reconfiguring a first subscription communication link (e.g., an Event 1D report related to cell reselection, or transmission and/or reception of a Radio Resource Controller (RRC) reconfiguration message) or a request for such information. The critical communication activity may relate to (e.g., may include transmission and/or reception of) Serving Cell Change (SSC) messaging, intra-RAT (IRAT) messaging (including IRAT handover information), Active Set update and/or confirmation messaging, and other communication activities related to configuring or reconfiguring a communication link between the multi-subscription multi-standby communication device and the first subscription communication network.

A critical communication activity may include one or more messages sent and/or received by the multi-subscription multi-standby communication device that include information vital to establishing, maintaining, or changing a communication link between the multi-subscription multi-standby communication device and a communication network. For example, a measurement report that the multi-subscription multi-standby communication device sends to initiate a serving cell change may be a critical communication. An RRC_Reconfiguration message from the communication network may also be critical communication. Critical communication messages may also include an RRC_Reconfiguration Complete message that the multi-subscription multi-standby communication device sends to the communication network. As another example, critical communication may include a cell change command that the communication network sends in response to a measurement report (such as an Event 1D measurement Report) that the multi-subscription multi-standby communication device sends to the communication network. In the case of such a critical communication, the multi-subscription multi-standby communication device may anticipate the arrival of the cell change command at a determinable time, or within a determinable time period following transmission of the measurement report.

As another example, receiving an activation time parameter that the communication network sends to the multi-subscription multi-standby communication device (e.g., in a RadioBearerSetup message or RadioBearerReconfig message) may be a critical communication activity. Further, a response to the activation time parameter from the multi-subscription multi-standby communication device, such as an RBSetupComplete or an RBReconfigComplete message may be a critical communication activity.

As another example, a Radio Link Control (RLC) message from the multi-subscription multi-standby communication device to the communication network (e.g., RLC Ack, RLC Reset, and other similar RLC call maintenance messages) may be a critical communication activity. Critical communication activities may also include other messages related to establishing, maintaining, or changing a communication link between the multi-subscription multi-standby communication device and a communication network, including combinations of the foregoing. In response to determining that the upcoming communication activity is not a critical communication activity (i.e., determination block 406=“No”), the device processor may perform the tune-away in block 410 and perform the first subscription communication activity in block 412. The performance of the first subscription communication activity may or may not collide with the tune-away. Additionally, the device processor may perform the first subscription communication activity before, during, or after the tune-away. The device processor may determine the timing of another upcoming tune-away in block 402.

In response to determining that the upcoming communication activity is a critical communication activity (i.e., determination block 406=“Yes”), the device processor may determine whether the tune-away and the critical communication activity will collide (i.e., overlap partly or completely in time) in determination block 408. In response to determining that the tune-away and the critical communication activity will not collide (i.e., determination block 408=“No”), the device processor may perform the tune-away in block 410 and perform the first subscription communication activity in block 412. The performance of the first subscription communication activity may or may not collide with the tune-away. Additionally, the device processor may perform the first subscription communication activity before, during, or after the tune-away. The device processor may determine the timing of another upcoming tune-away in block 402.

In response to determining that the tune-away and the critical communication activity will collide (i.e., determination block 408=“Yes”), the device processor may determine one or more characteristics of the communication link between the multi-subscription multi-standby communication device and the first subscription communication network in block 414. In some embodiments, determining one or more characteristics of the communication link may include estimating one or more characteristics of the communication link.

In various embodiments, the characteristics of the communication link may include a signal level (e.g., a signal strength and/or signal quality, such as a common pilot channel (CPICH) signal to noise ratio (SNR) estimate, or a channel quality indicator (CQI) of a signal of the communication link). Communication link characteristics may also include a transmission power of a signal of the communication link (e.g., receiving one or more transmit power control (TPC) symbols of the signal of the communication link, such as determining whether a number of instructions to increase transmit power over a period of time exceed a threshold), and a spectral density of the signal of the communication link (e.g., signal energy over interference, such as Ec/Io). Communication link characteristics may also include a block error rate (BLER) of the signal of the communication link, and an estimate of a speed and/or direction of motion of the multi-subscription multi-standby communication device.

The characteristics of the communication link may also include a number of channel grants received from the first subscription (e.g., as may be received by the multi-subscription multi-standby communication device from the first subscription communication network over an Access Grant Channel (AGCH) or a Relative Grant Channel (RGCH)), a number of ACKs (i.e., data-received indications) sent to or received from the first subscription communication network, and/or a number of NACKs (i.e., data-not received indications) sent to or received from the first subscription communication network. In some embodiments, the ACKs and/or NACKs may be sent by the multi-subscription multi-standby communication device to the first subscription communication network and/or received by the multi-subscription multi-standby communication device from the first subscription communication network over a Hybrid Automatic Request (ARQ) Indicator Channel (HICH). One or more of the communication link characteristics may be determined over a period of time. The communication link characteristics may further include combinations of any of the foregoing.

In block 416, the device processor may schedule the critical communication activity on the first subscription to prevent the collision between the upcoming critical communication activity and the upcoming tune-away based on the determined (and/or estimated) one or more communication link characteristics.

Additionally or alternatively, in block 417, the device processor may schedule the tune-away from the first subscription to the second subscription to prevent the collision between the upcoming critical communication activity and the upcoming tune-away based on the determined (and/or estimated) one or more communication link characteristics. Thus, the device processor may schedule one or both of the upcoming critical communication activity and the upcoming tune-away to prevent the collision in response to determining that the upcoming tune-away and the upcoming communication activity on the first subscription will collide.

In some embodiments, based on the one or more communication link characteristics, the device processor may schedule the critical communication activity and/or the tune-away such that the device processor performs the critical communication before the upcoming tune-away. In some embodiments, based on the one or more communication link characteristics, the device processor may schedule the critical communication activity and/or the tune-away such that the device processor performs the critical communication after the upcoming tune-away. In some embodiments, based on the one or more communication link characteristics, the device processor may schedule (before or after the tune-away) a first communication activity such that the second communication activity that is related to the first communication activity does not coincide (i.e., does not collide) with the tune-away. In some embodiments, the device processor may also use the duration of the upcoming tune-away to determine whether to schedule the critical communication activity around (e.g., before or after) the tune-away, or to re-schedule the tune-away around (e.g., before or after) the critical communication activity.

For example, the device processor may receive from the communication network an activation time parameter indicating an activation time period.

Typically, the device processor may respond to the communication network with a completion response (e.g., an RRC_Reconfig_Complete message) after the activation time period expires. The completion response is an example of a critical communication activity. In some embodiments, the device processor may disregard the activation time period and may schedule sending the completion response before or after the tune-away. In other words, in block 416 the device may schedule the critical communication activity to avoid overlapping with the tune-away (e.g., the device processor may schedule the response to the activation time parameter to avoid coinciding with an upcoming tune-away). In some embodiments, the device processor may reschedule an upcoming tune-away to not coincide with the end of the activation time period (and thus the sending of the completion response). In other words, in block 417 the device processor may schedule an upcoming tune-away to avoid overlapping with the critical communication activity (e.g., the device processor may schedule a tune-away to not coincide with the anticipated end of the activation time period indicated by the activation time parameter).

As another example, the device processor may schedule a Radio Link Control (RLC) message from the multi-subscription multi-standby communication device to the communication network (e.g., RLC Ack, RLC Reset, and other similar RLC call maintenance messages), or a message related to establishing, maintaining, or changing a communication link between the multi-subscription multi-standby communication device and a communication network, to prevent such communications coinciding with a tune-away. In some embodiments, the device processor may adjust a tune-away timing parameter to schedule the critical communication activity and/or the tune-away. The tune-away timing parameter may include a tune-away gap length threshold, a gap time period or buffer time period before and/or after the tune-away, or another timing parameter related to the tune-away. In some embodiments, the device processor may adjust a communication activity timing parameter to schedule the critical communication to prevent the communication from coinciding with the tune-away. The communication activity timing parameter may include a time-to-trigger (TTT) selection and/or the activation time parameter.

In some embodiments, the device processor may determine an amount of adjustment of the tune-away timing/measurement parameter and/or the communication activity timing parameter based on the one or more determined characteristics of the communication link between the multi-subscription multi-standby communication device and the first communication network. For example, the device processor may reduce the value of one or more tune-away timing/measurement parameters and/or communication activity timing parameters as an estimated speed and/or distance of the multi-subscription multi-standby communication device from a base station increases. Conversely, the device processor may increase the value of one or more tune-away timing/measurement parameters and/or communication activity timing parameters as the estimated speed and/or distance of the multi-subscription multi-standby communication device from the base station decreases. As another example, the device processor may reduce the value of one or more tune-away timing/measurement parameters and/or communication activity timing parameters as a signal level of a signal of the communication link decreases, and the device processor may increase the value of one or more tune-away timing parameters as the signal level increases. The device processor may also use other determined characteristics of the communication link to determine the amount of adjustment to one or more tune-away timing/measurement parameters and/or communication activity timing parameters. In some embodiments, the device processor may also determine an amount of adjustment of the one or more tune-away timing/measurement parameters and/or communication activity timing parameters based on the duration of the upcoming tune-away.

In general, as the determined characteristic(s) of the communication link indicate that the communication link is decreasingly robust and/or reliable, the device processor may reduce the value of one or more tune-away timing parameters. Similarly, as the determined characteristic(s) of the communication link indicate that the communication link is increasingly robust and/or reliable, the device processor may increase the value of one or more tune-away timing parameters. In some embodiments, the amount of adjustment to the tune-away parameter(s) may be determined by the device processor using one or more of: the signal level of a signal of the communication link (e.g., a CPICH SNR estimate, or a CQI); the transmission power of a signal of the communication link; the spectral density of the signal of the communication link (e.g., signal energy over interference, such as Ec/lo); TPC symbols of the first subscription received by the multi-subscription multi-standby communication device (e.g., determining whether a number of instructions to increase transmit power over a period of time exceed a threshold); the BLER of the signal of the communication link; the estimate of the speed and/or direction of motion of the multi-subscription multi-standby communication device; the number of channel grants received from the first subscription; the number of ACKs sent to or received from the first subscription communication network; and the number of NACKs sent to or received from the first subscription communication network.

In block 418, the device processor may perform the critical communication activity on the first subscription. In block 420, the device processor may perform the tune-away. In some embodiments, according to the schedule (e.g., from block 416 and/or block 417), the device processor may perform the critical communication activity before or after the tune-away. In some embodiments, according to the schedule, the device processor may perform a first communication activity so that a second communication activity (which is, in this case, the critical communication activity) is performed before or after the tune-away. Thus, the device processor may perform either or both of the critical communication activity and the tune-away to prevent the collision.

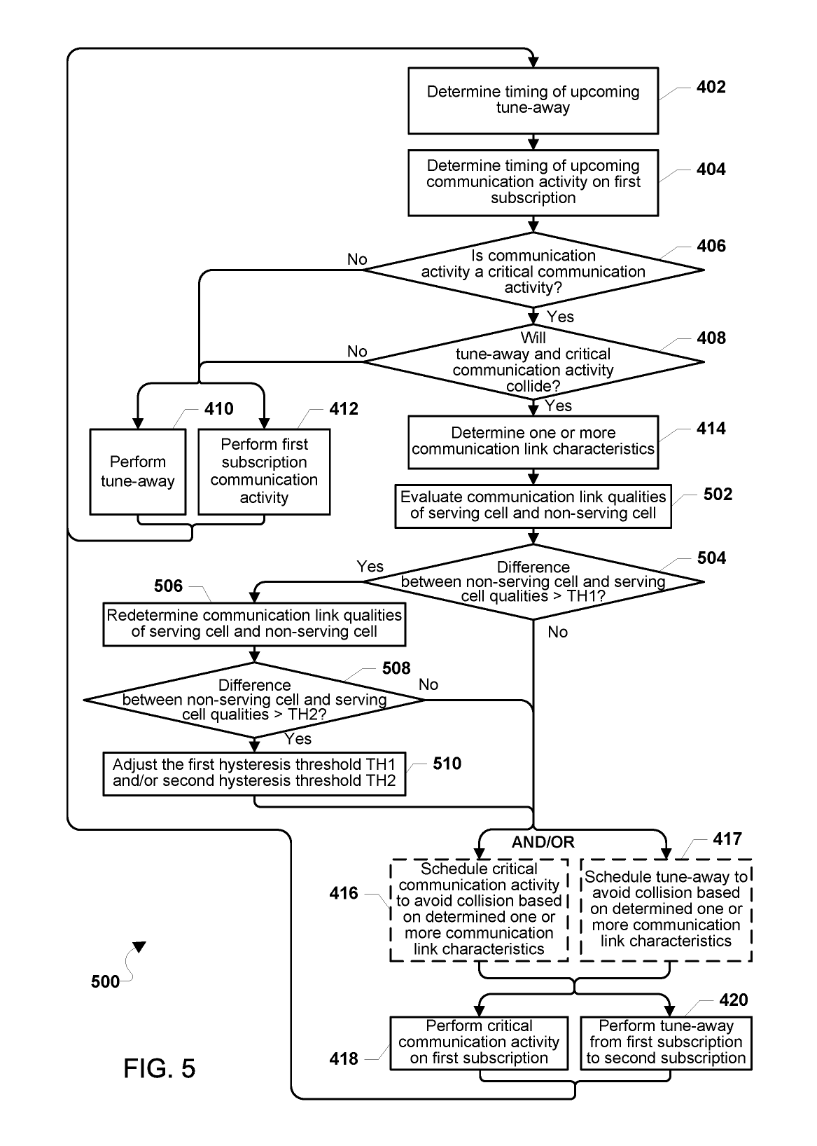

FIG. 5 illustrates a method 500 for managing communication activity on a first subscription to protect a critical first subscription communication activity from a tune-away according to some embodiments. With reference to FIGS. 1-5, the method 500 may be implemented by a multi-subscription multi-standby communication device (e.g., the multi-subscription multi-standby communication device 102, 200), such as under the control of a processor (e.g., the general-purpose processor 206, the baseband processor 216, a separate controller, and/or the like) of the multi-subscription multi-standby communication device (i.e., a device processor). In blocks 402-420, the device processor may perform operations of like numbered blocks of the method 400.

In some embodiments, the device processor may adjust one or more tune-away hysteresis thresholds to schedule the critical communication activity in block 416 and/or schedule the tune-away in block 417. For example, the critical communication activity may include evaluating communication link qualities of a serving cell and a non-serving cell of the first subscription to determine whether to change to the non-serving cell.

As described, in response to determining that the tune-away and the critical communication activity will collide (i.e., determination block 408 =“Yes”), the device processor may determine one or more characteristics of the communication link between the multi-subscription multi-standby communication device and the first subscription communication network in block 414.

In block 502, the device processor may evaluate communication link qualities of a serving cell and communication link qualities of a non-serving cell of the first subscription.

In determination block 504, the device processor may determine whether a difference between a communication link quality of a serving cell of the first subscription (e.g., associated with the first communication network) and a non-serving cell of the first subscription (e.g., also associated with the first subscription) exceeds a first hysteresis threshold (TH1). For example, the device processor may compare a communication link quality of the non-serving cell and a communication link quality of the serving cell to one or more hysteresis threshold(s) before performing a tune-away.

In response to determining that the difference between the communication link qualities of the non-serving cell and serving cell does not exceed the first hysteresis threshold (i.e., determination block 504=“No”), the device processor may schedule the critical communication activity in block 416 and/or schedule the tune-away in block 417. As described, the device processor may adjust one or more tune-away hysteresis thresholds to schedule the critical communication activity in block 416 and/or schedule the tune-away in block 417. For example, the device processor may schedule the critical communication activity and/or the tune-away based on communication link qualities of the serving cell and the non-serving cell of the first subscription determined in block 502, such as to determine whether to change to the non-serving cell.

In response to determining that the difference between the communication link qualities of the non-serving cell and the serving cell exceeds the first hysteresis threshold (i.e., determination block 504=“Yes”), the device processor may redetermine communication link qualities of the non-serving cell and the serving cell in block 506.

In determination block 508, the device processor may determine whether a difference between the redetermined communication link quality of the serving cell and the redetermined communication link quality of the non-serving cell exceeds a second hysteresis threshold (TH2).

In response to determining that the difference between the redetermined communication link qualities of the non-serving cell and serving cell does not exceed the second hysteresis threshold (i.e., determination block 508=“No”), the device processor may schedule the critical communication activity in block 416 and/or schedule the tune-away in block 417 as described.

In response to determining that the difference between the redetermined communication link qualities of the non-serving cell and serving cell exceeds the second hysteresis threshold (i.e., determination block 508=“Yes”), the device processor may adjust the first and/or second hysteresis thresholds in block 510. In some embodiments, the device processor may adjust the first and/or second hysteresis thresholds based on the duration of the upcoming tune-away. In some embodiments, the device processor may adjust the first and/or second hysteresis thresholds based on one or more communication link characteristics. The device processor may schedule the critical communication activity in block 416 and/or schedule the tune-away in block 417 as described.

Following blocks 416 and/or 417 (which follow blocks 504, 508, or 510), the device processor may then perform the critical communication activity in block 418 or perform the tune-away in block 420. The critical communication activity may include sending measurement event information on the first subscription (e.g., an event 1D report).

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the timelines 300A and 300B and the methods 400 and 500 may be substituted for or combined with one or more operations of the timelines 300A and 300B and the methods 400 and 500.

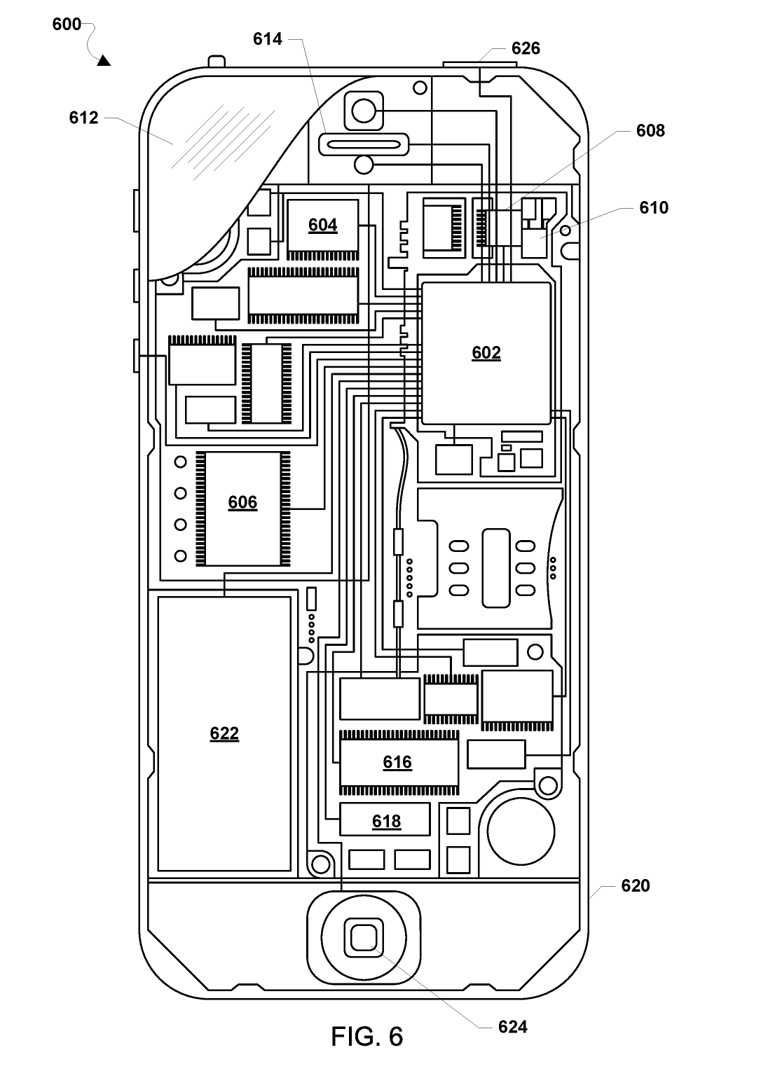

Various embodiments (including, but not limited to, embodiments described with reference to FIGS. 1-5) may be implemented in any of a variety of multi-subscription multi-standby communication devices, an example of which (e.g., multi-subscription multi-standby communication device 600) is illustrated in FIG. 6. With reference to FIGS. 1-6, in various embodiments, the multi-subscription multi-standby communication device 600 (which may correspond, for example, to the multi-subscription multi-standby communication devices 102 and 200) may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may be secure and/or encrypted memory, or unsecure and/or unencrypted memory, or any combination thereof The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the multi-subscription multi-standby communication device 600 need not have touch screen capability.

The multi-subscription multi-standby communication device 600 may have two or more radio signal transceivers 608 (e.g., Peanut, Bluetooth, ZigBee, Wi-Fi, RF radio) and antennae 610, for sending and receiving communications, coupled to each other and/or to the processor 602. The transceivers 608 and antennae 610 may be used with the above-mentioned circuitry to implement the various wireless transmission protocol stacks and interfaces. The multi-subscription multi-standby communication device 600 may include one or more cellular network wireless modem chip(s) 616 coupled to the processor and antennae 610 that enable communication via two or more cellular networks via two or more radio access technologies.

The multi-subscription multi-standby communication device 600 may include a peripheral device connection interface 618 coupled to the processor 602. The peripheral device connection interface 618 may be singularly configured to accept one type of connection, or may be configured to accept various types of physical and communication connections, common or proprietary, such as USB, FireWire, Thunderbolt, or PCIe. The peripheral device connection interface 618 may also be coupled to a similarly configured peripheral device connection port (not shown).

The multi-subscription multi-standby communication device 600 may also include speakers 614 for providing audio outputs. The multi-subscription multi-standby communication device 600 may also include a housing 620, constructed of plastic, metal, or a combination of materials, for containing all or some of the components discussed herein. The multi-subscription multi-standby communication device 600 may include a power source 622 coupled to the processor 602, such as a disposable or rechargeable battery. The rechargeable battery may also be coupled to the peripheral device connection port to receive a charging current from a source external to the multi-subscription multi-standby communication device 600. The multi-subscription multi-standby communication device 600 may also include a physical button 624 for receiving user inputs. The multi-subscription multi-standby communication device 600 may also include a power button 626 for turning the multi-subscription multi-standby communication device 600 on and off

The processor 602 may be any programmable microprocessor, microcomputer or multiple processor chip or chips that can be configured by software instructions (applications) to perform a variety of functions, including the functions of various embodiments described below. In some multi-subscription multi-standby communication devices, multiple processors 602 may be provided, such as one processor dedicated to wireless communication functions and one processor dedicated to running other applications. Typically, software applications may be stored in the internal memory 606 before they are accessed and loaded into the processor 602. The processor 602 may include internal memory sufficient to store the application software instructions.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of various embodiments.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features disclosed herein.

What is claimed is:

1. A method implemented on a multi-subscription multi-standby communication device for managing communication activity, comprising:
determining a timing of an upcoming tune-away from a first subscription to a second subscription;
determining whether an upcoming communication activity on the first subscription is a critical communication activity;
determining whether a collision will occur between the upcoming tune-away and the upcoming communication activity in response to determining that the upcoming communication activity is an upcoming critical communication activity; and
scheduling one or both of the upcoming critical communication activity and the upcoming tune-away to prevent the collision in response to determining that the upcoming tune-away and the upcoming communication activity will collide.

2. The method of claim 1, further comprising performing the critical communication activity and the tune-away as scheduled to prevent the collision.

3. The method of claim 1, wherein the upcoming critical communication activity is one of a transmission activity or a reception activity.

4. The method of claim 1, wherein the upcoming critical communication activity relates to a serving cell change.

5. The method of claim 4, wherein the upcoming critical communication activity comprises one or more of a measurement of a serving cell signal, a measurement of a neighbor cell signal, information related to reconfiguring a communication link, a request for information related to reconfiguring a communication link, intra-radio access technology messaging, active set update messaging, and active set confirmation messaging.

6. The method of claim 1, wherein scheduling one or both of the upcoming critical communication activity and the upcoming tune-away to prevent the collision in response to determining that the upcoming tune-away and the upcoming communication activity will collide comprises scheduling a transmission activity such that a reception activity related to the transmission activity does not coincide with the tune-away.

7. The method of claim 1, wherein scheduling one or both of the upcoming critical communication activity and the upcoming tune-away to prevent the collision in response to determining that the upcoming tune-away and the upcoming communication activity will collide comprises:
determining one or more characteristics of a communication link of the multi-subscription multi-standby communication device on the first subscription; and
scheduling the one or both of the upcoming critical communication activity and the upcoming tune-away to prevent the collision based on the determined one or more characteristics of the communication link.

8. The method of claim 7, wherein the one or more characteristics of the communication link of the multi-subscription multi-standby communication device on the first subscription comprises one or more of a signal level of a signal of the communication link, a transmission power of the signal of the communication link, a spectral density of the signal of the communication link, a block error rate (BLER) of the signal of the communication link, a number of channel grants received from a communication network of the first subscription, a number of data-received indications received from the communication network, a number of data-received indications sent to the communication network, a number of data-not received indications received from the communication network, a number of data-not received indications sent to the communication network, a speed of motion of the multi-subscription multi-standby communication device, a direction of motion of the multi-subscription multi-standby communication device, a High Speed Physical Download Shared Channel (HS-PDSCH) signal-to-noise ratio, and an estimate of a Radio Link Control (RLC) acknowledgement delay.

9. The method of claim 1, wherein scheduling one or both of the upcoming critical communication activity and the upcoming critical communication activity to prevent the collision in response to determining that the upcoming tune-away and the upcoming communication activity will collide comprises scheduling the critical communication activity before the tune-away.

10. The method of claim 1, wherein scheduling one or both of the upcoming critical communication activity and the upcoming tune-away to prevent the collision in response to determining that the upcoming tune-away and the upcoming communication activity will collide comprises scheduling the critical communication activity after the tune-away.

11. The method of claim 1, wherein scheduling one or both of the upcoming critical communication activity and the upcoming tune-away to prevent the collision in response to determining that the upcoming tune-away and the upcoming communication activity will collide comprises scheduling the critical communication activity before the tune-away by adjusting a tune-away timing parameter.

12. The method of claim 1, wherein scheduling one or both of the upcoming critical communication activity and the upcoming tune-away to prevent the collision in response to determining that the upcoming tune-away and the upcoming communication activity will collide comprises adjusting a communication activity timing parameter.

13. A multi-subscription multi-standby communication device for managing communication activity , comprising:
a memory;
a radio frequency resource; and
a processor coupled to the memory and the radio frequency resource and configured with processor-executable instructions to:
determine a timing of an upcoming tune-away from a first subscription to a second subscription;
determine whether an upcoming communication activity on the first subscription is a critical communication activity;
determine whether a collision will occur between the upcoming tune-away and the upcoming communication activity in response to determining that the upcoming communication activity is an upcoming critical communication activity; and
schedule one or both of the upcoming critical communication activity and the upcoming tune-away to prevent the collision in response to determining that the upcoming tune-away and the upcoming communication activity will collide.

14. The multi-subscription multi-standby communication device of claim 13, wherein the processor is further configured with processor-executable instructions to perform the critical communication activity and the tune-away as scheduled to prevent the collision.

15. The multi-subscription multi-standby communication device of claim 13, wherein the upcoming critical communication activity is one of a transmission activity or a reception activity.

16. The multi-subscription multi-standby communication device of claim 13, wherein the upcoming critical communication activity relates to a serving cell change.

17. The multi-subscription multi-standby communication device of claim 16, wherein the upcoming critical communication activity comprises one or more of a measurement of a serving cell signal, a measurement of a neighbor cell signal, information related to reconfiguring a communication link, a request for information related to reconfiguring a communication link, intra-radio access technology messaging, active set update messaging, and active set confirmation messaging.

18. The multi-subscription multi-standby communication device of claim 13, wherein the processor is further configured with processor-executable instructions to schedule a transmission activity such that a reception activity related to the transmission activity does not coincide with the tune-away.

19. The multi-subscription multi-standby communication device of claim 13, wherein the processor is further configured with processor-executable instructions to:
determine one or more characteristics of a communication link of the multi-subscription multi-standby communication device on the first subscription; and
schedule the one or both of the upcoming critical communication activity and the upcoming tune-away to prevent the collision based on the determined one or more characteristics of the communication link.

20. The multi-subscription multi-standby communication device of claim 19, wherein the one or more characteristics of the communication link of the multi-subscription multi-standby communication device on the first subscription comprises one or more of a signal level of a signal of the communication link, a transmission power of the signal of the communication link, a spectral density of the signal of the communication link, a block error rate (BLER) of the signal of the communication link, a number of channel grants received from a communication network of the first subscription, a number of data-received indications received from the communication network, a number of data-received indications sent to the communication network, a number of data-not received indications received from the communication network, a number of data-not received indications sent to the first subscription communication network, a speed of motion of the multi-subscription multi-standby communication device, a direction of motion of the multi-subscription multi-standby communication device, a High Speed Physical Download Shared Channel (HS-PDSCH) signal-to-noise ratio, and an estimate of a Radio Link Control (RLC) acknowledgement delay.

21. The multi-subscription multi-standby communication device of claim 13, wherein the processor is further configured with processor-executable instructions to schedule the critical communication activity before the tune-away.

22. The multi-subscription multi-standby communication device of claim 13, wherein the processor is further configured with processor-executable instructions to schedule the critical communication activity after the tune-away.

23. The multi-subscription multi-standby communication device of claim 13, wherein the processor is further configured with processor-executable instructions to schedule the critical communication activity before the tune-away by adjusting a tune-away timing parameter.

24. The multi-subscription multi-standby communication device of claim 13, wherein scheduling one or both of the upcoming critical communication activity and the upcoming tune-away in response to determining that the upcoming tune-away and the upcoming communication activity will collide comprises adjusting a communication activity timing parameter to prevent the collision.

25. A multi-subscription multi-standby communication device, comprising:
means for determining a timing of an upcoming tune-away of a radio frequency (RF) resource of the multi-subscription multi-standby communication device from a first subscription to a second subscription;
means for determining whether an upcoming communication activity on the first subscription is a critical communication activity;
means for determining whether a collision will occur between the upcoming tune-away and the upcoming communication activity in response to determining that the upcoming communication activity is an upcoming critical communication activity; and
means for scheduling one or both of the upcoming critical communication activity and the upcoming tune-away to prevent the collision in response to determining that the upcoming tune-away and the upcoming communication activity will collide.

26. A non-transitory processor-readable storage medium having stored thereon processor-executable instructions configured to cause a processor of a multi-subscription multi-standby communication device to perform operations comprising:
determining a timing of an upcoming tune-away from a first subscription to a second subscription;
determining whether an upcoming communication activity on the first subscription is a critical communication activity;
determining whether a collision will occur between the upcoming tune-away and the upcoming communication activity in response to determining that the upcoming communication activity is an upcoming critical communication activity; and
scheduling one or both of the upcoming critical communication activity and the upcoming tune-away to prevent the collision in response to determining that the upcoming tune-away and the upcoming communication activity will collide.

27. The non-transitory processor-readable storage medium of claim 26, wherein the stored processor-executable instructions are configured to cause the processor of the multi-subscription multi-standby communication device to perform operations further comprising performing the critical communication activity and tune-away as scheduled to prevent the collision.

28. The non-transitory processor-readable storage medium of claim 26, wherein the stored processor-executable instructions are configured to cause the processor of the multi-subscription multi-standby communication device to perform operations such that the upcoming critical communication activity is one of a transmission activity or a reception activity.

29. The non-transitory processor-readable storage medium of claim 26, wherein the stored processor-executable instructions are configured to cause the processor of the multi-subscription multi-standby communication device to perform operations such that the upcoming critical communication activity relates to a serving cell change.

30. The non-transitory processor-readable storage medium of claim 29, wherein the upcoming critical communication activity comprises one or more of a measurement of a serving cell signal, a measurement of a neighbor cell signal, information related to reconfiguring a communication link, a request for information related to reconfiguring a communication link, intra-radio access technology messaging, active set update messaging, and active set confirmation messaging.
